(19) United States
(12) Patent Application Publication
(10) Pub. No.: US 2022/0372944 A1
(43) Pub. Date: Nov. 24, 2022

(54) METHODS AND APPARATUS FOR MOVING FLUID USING A NEW BLADE SHAPE

(71) Applicant: Chris Rorres, Wynnewood, PA (US)

(72) Inventor: Chris Rorres, Wynnewood, PA (US)

(73) Assignee: Chris Rorres, Wynnewood, PA (US)

(21) Appl. No.: 17/719,566

(22) Filed: Apr. 13, 2022

Related U.S. Application Data
(60) Provisional application No. 63/190,941, filed on May 20, 2021.

(51) Int. Cl. F03B 3/10

(52) U.S. Cl. CPC F03B 3/103; F05B 2240/243; F05B 2260/422; F05B 2200/13; F05B 2200/261; F05B 2200/262; F05B 2200/12; F05B 2200/11

(57) ABSTRACT

The present invention provides improved methods, apparatus, and manufacture for an Archimedes Screw using a new blade design to increase the volume of water raised or lowered by about 9%-18%. The invention, in part alters the shape of the blades within the screw from a helicoid shape to a new shape called a “makroid” by the inventor. A helicoid blade in an Archimedes Screw has been used since antiquity and has not changed since then, limiting the efficiency. The makroid shape allows a greater quantity of water to be contained within the screw.

### CROSS REFERENCE TO RELATED APPLICATIONS

This application is a US non-provisional application that claims priority to U.S. Provisional Application No. 63/190,941, filed 20 May 2021, now expired, the disclosure of which is herein incorporated by reference in its entirety.

### BACKGROUND

### Field of Invention

The present invention relates to methods and apparatus for raising or lowering a volume of a fluid such as water using an Archimedes screw-type device. More specifically, the present invention incorporates a novel shape as a blade to increase the volume of fluid previously obtained using a helicoid shape. This novel shape is called a “makroid” by the inventor.

### Description of Related Art

The Archimedes Screw is a device used to raise or lower a fluid, usually water, from one level to another. When used for raising water, energy is supplied to turn the screw, and when used to lower water, energy is generated by the turning of the screw.

The Archimedes Screw is one of the oldest machines in use. Its invention has traditionally been credited to Archimedes, an ancient Greek mathematician and engineer, who lived in the third century BC.

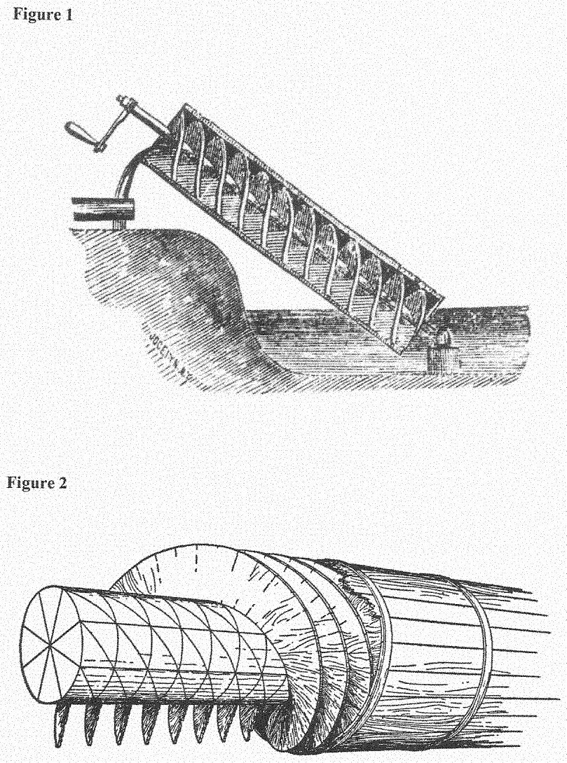

FIG. 1 shows the basic design of an Archimedes Screw from antiquity that is used to raise water. It consists of an inner cylinder or core wrapped by blades (also called “starts” or “flights”) and an outer cylinder enclosing the blades. Its bottom end is immersed in a body of water (the “lower reservoir”) and water is raised to the top end (the “upper reservoir”). When tilted as shown, water is trapped in “buckets” formed by the two cylinders and the blades. As the entire devise is rotated by the crank at the top, the action of the clockwise screw motion causes these buckets of water to be lifted from the lower to the upper reservoir.

In antiquity and up to the last century, the main uses of the Archimedes Screw were to irrigate fields from a low-lying stream or river; to raise storm water out of low-lying land; and to drain water from mines.

FIG. 2 is an illustration of an Archimedes Screw described by the Roman Engineer Vitruvius in the first century BC. The inner cylinder is shaped from the trunk of a tree, the outer cylinder is constructed from planks, and the eight intertwined blades are built up from the long flexible twigs from willow trees. All parts were nailed together and sealed with tar to eliminate leakages. The blade shape in FIG. 2 is called a helicoid and has so far been the only shape used for commercial Archimedes Screws.

Present-day uses of the Archimedes Screw include applications in wastewater treatment facilities, low-lying land pumping stations (such as found in The Netherlands or the Gulf coast region), irrigation systems, rain-detention dams, flood-detention dams, fish-conveyor systems, sea-salt evaporation ponds, water sports, and recreational activities. All of these application make use of the helicoid blade design.

Within the United States the Archimedes Screw is used most frequently to raise water in wastewater treatment plants and low-lying land pumping stations.

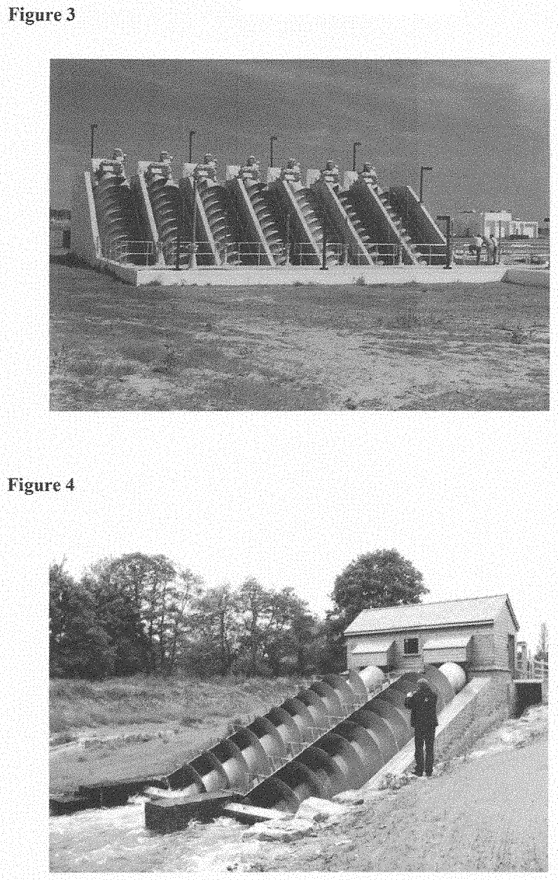

FIG. 3 shows seven Archimedes Screws used to pump wastewater in a treatment plant in Memphis, Tenn., USA. Each of these Screws is 96 inches (2.44 meters) in diameter and can lift 9,900 gallons (37.5 cubic meters) per minute. The Screws were manufactured by the Lakeside Equipment Company of Bartlett, Ill., USA. In modern installations, the outer cylinder that covered the screw in antiquity is usually replaced by a stationary half-cylinder trough in which the screw blades attached to the inner cylinder rotate. When used to raise water, the screw is turned by an electric or diesel motor.

Within the last twenty-five years, a new application of the screw has been discovered in the generation of electricity. For such applications, Archimedes Screws are also called hydropower screws.

FIG. 4 shows one such installation in Germany in which two screws are set next to a stream and part of the flow of the stream at the top is diverted to the top of the screws. The weight of the water causes the screws to turn, driving an electrical generator located in the shed. There are hundreds of sites throughout Europe equipped with these hydropower screws, and they are now becoming available in the United States.

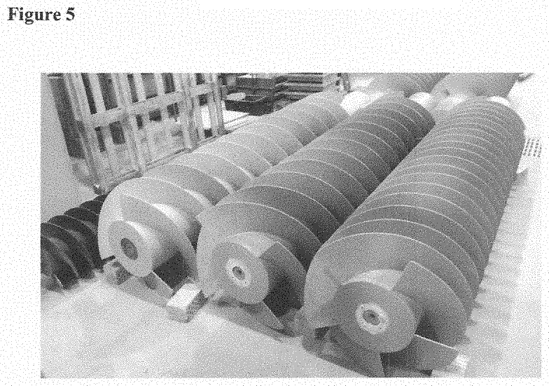

FIG. 5 shows screws in a manufacturing plant. Almost all screws manufactured today have 3, 4, or 5 intertwined helicoid blades, as shown.

In each of the uses described above, the screw is designed with a helicoid shape that has a limited fluid volume available for filling each bucket during movement of the screw. Therefore, there exists a need to increase the capacity of individual buckets and thus improve the efficiency of fluid being moved through the screw.

### SUMMARY

The present invention uses a blade design called a “makroid” by the inventor to increase the volume of water raised or lowered by about over the existing helicoid design. The increase in volume depends on the basic design parameters of the screw (i.e., the number of intertwined blades, the tilt angle of the screw, the ratio of the radii of the inner and outer cylinders, and the ratio of the outer diameter to the pitch), but typical values are from 10% to 17%. The invention, in part, alters the shape of the blades within the screw from a helicoid shape to a makroid shape. A helicoid blade in an Archimedes Screw has been used since antiquity and has not changed since then, limiting its efficiency. The makroid shape allows a greater quantity of water to be contained within the screw.

Thus, the present invention describes a more efficient makroid blade with applications wherever a volume of fluid is needed to be moved between a lower reservoir and an upper reservoir. The fluid is usually water, but is applicable to any type of liquid needed to be raised or lowered from one reservoir to another. Because the present invention increases the quantity of fluid per bucket, contents in the fluid are less subject to damage. Contents in the fluid could include wildlife such as fish when the invention is applied with a moving body of water such as a creek or stream. The present invention also has applications for moving granular material such as, but not limited to, sand upward from a lower reservoir to an upper reservoir, having applications in filling sandbags and the like.

Finally, the present invention has applications in generating electricity using fluid movement down the device in order to rotate generators (hydropower screws).

### BRIEF DESCRIPTION OF THE FIGS. 1-13

FIG. 1 An illustration of an Archimedes Screw from antiquity for raising water from a lower reservoir to an upper reservoir.

FIG. 2 An illustration of the internal design of an ancient Archimedes Screw showing helicoid blade shape.

FIG. 3 An image of an Archimedes Screw used in raise water at a wastewater treatment plant.

FIG. 4 An image of an Archimedes Screw used in hydro-electric power generation.

FIG. 5 An image of Archimedes Screws having helicoid blades with 3, 4, and 5 intertwined blades.

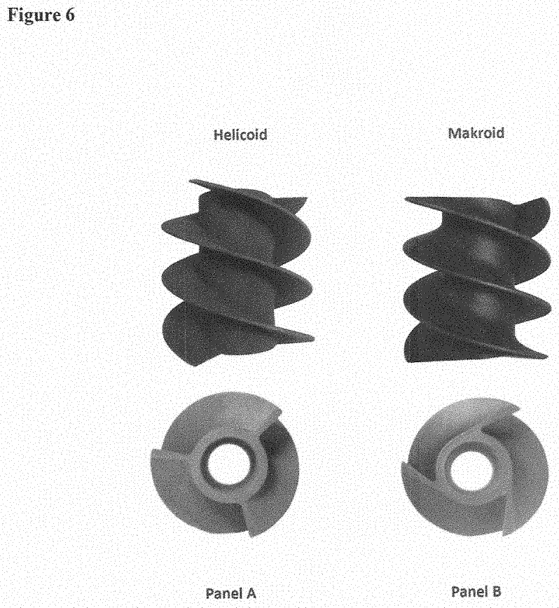

FIG. 6 Photographs of one pitch of a 3D printed screw with a helicoid blade design (Panel A) and a makroid blade design (Panel B). The top row shows profile views and the bottom row shows top views.

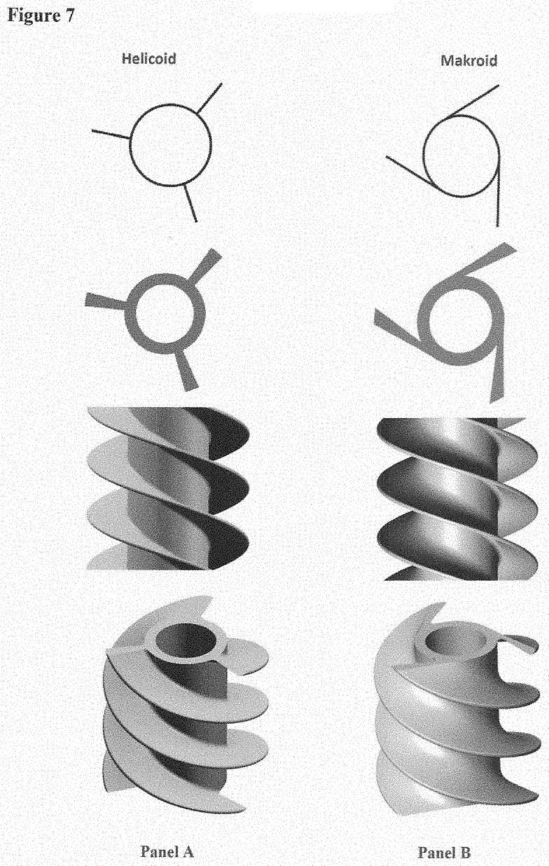

FIG. 7 Various illustrations of 3-bladed helicoid (Panel A) and makroid (Panel B) screws.

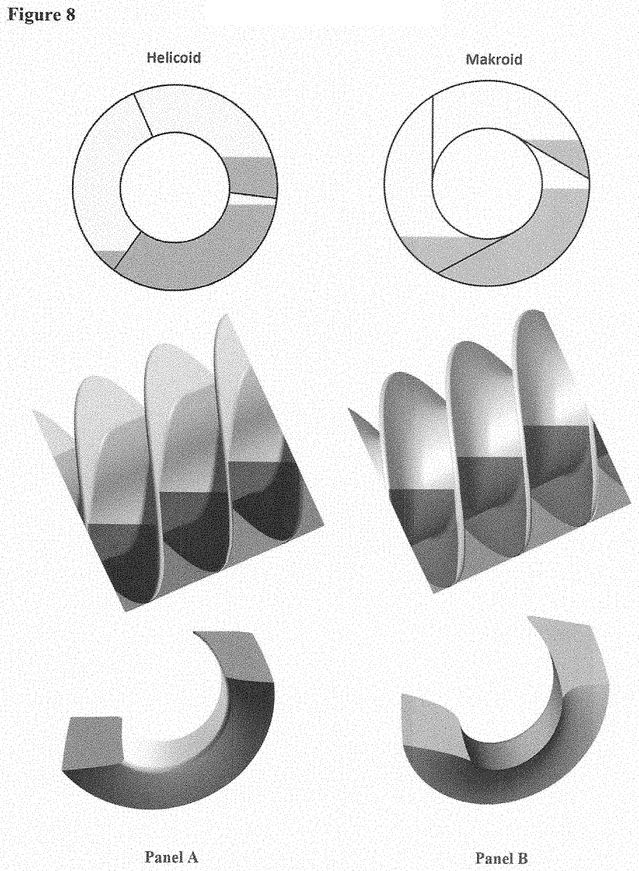

FIG. 8 Various illustrations of 3-bladed helicoid (Panel A) and makroid (Panel B) screws filled with water.

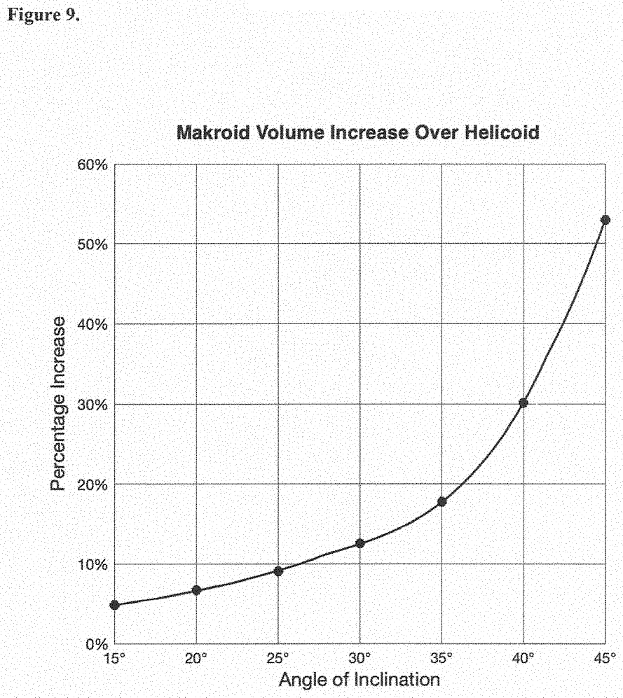

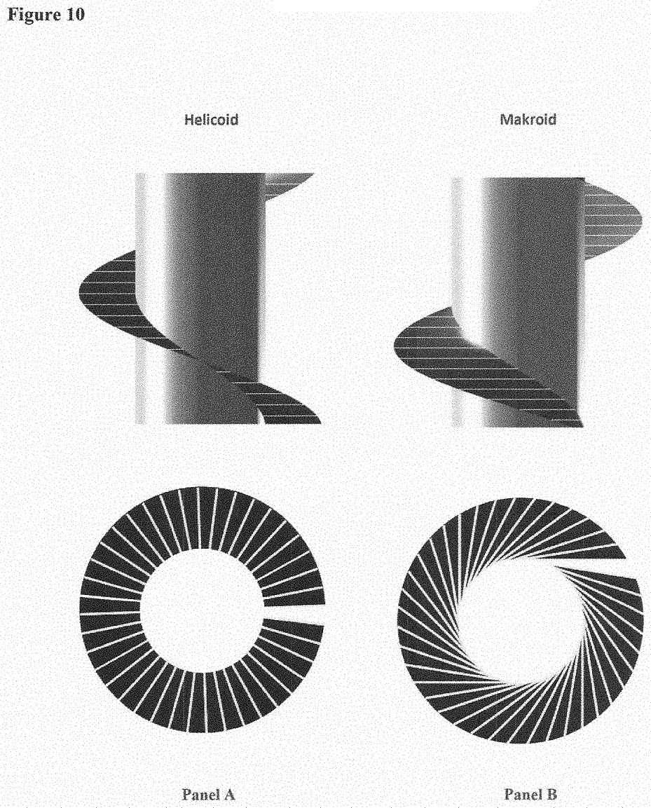

FIG. 9 Graph of the percentage increase in the bucket volume capacity of a makroid blade over that of a helicoid blade for a range of tilt angles of the screw.

FIG. 10 Top row: Profile views showing the straight-line generators of a helicoid (Panel A) and makroid (Panel B) blade. Bottom row: the blanks from which a single pitch of the screws is formed.

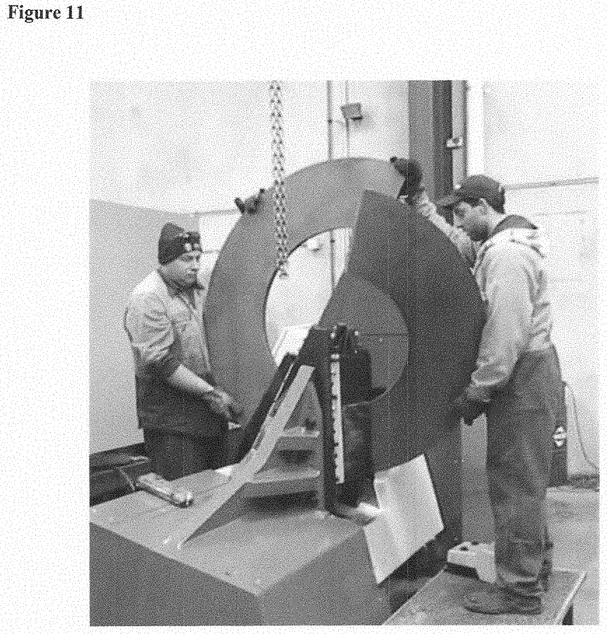

FIG. 11 Photograph showing the machinery used to form a single turn of a helicoid blade.

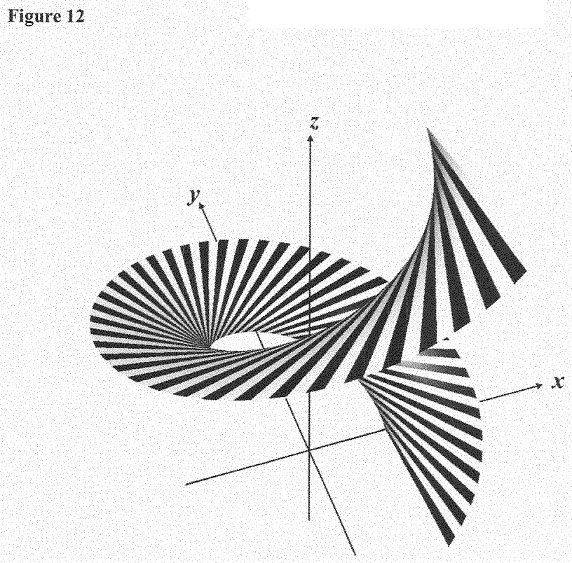

FIG. 12 An illustration of one turn of a makroid blade.

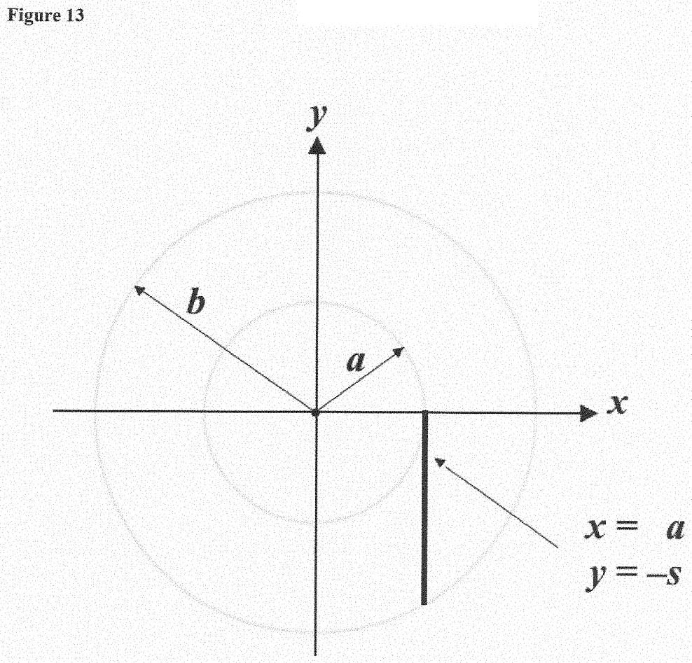

FIG. 13 An illustration of the cross-section of a makroid blade.

### DETAILED DESCRIPTION OF INVENTION

Panel A in FIG. 6 labelled ‘Helicoid’ shows two photographs of a segment of a 3D-printed Archimedes Screw with three blades of the design used since antiquity. The top photograph is a profile view of the screw and the bottom photograph is of the top of the screw. Panel B shows similar photographs for a makroid blade.

The embodiment of the present invention incorporates the makroid surface in the blades of an Archimedes Screw. For the screws in FIG. 6 a rotation in a clockwise direction (as viewed from the top) will lift water. When the screws are used to generate electricity, the weight of falling water will cause the screws to rotate clockwise.

Panel A in FIG. 7 shows four computer-generated images of a segment of a screw with helicoid blades and Panel B shows similar views for a makroid blade. The first row of images is of cross-sections of the screws when the blades and the cylinder to which they are attached have zero thickness. As can be seen, the cross-section of each helicoid blade is a straight line which, when extended, passes through the center of the screw; and the cross-section of each makroid blade is a straight line that is tangent to the inner cylinder to which it is attached.

The second row in FIG. 7 shows the same views when the blades have some non-zero thickness. The third row shows the profiles of a segment of the thick-bladed screws when the pitch of the screws is equal to its diameter. The bottom view shows oblique views of the two types of screw segments.

FIG. 8 shows various views of the helicoid and the makroid screws when tilted and filled with water. The first row shows a typical cross-section with the water shaded darkly. The second row shows tilted profiles of each of the two screw types with the water again shaded darkly. The third row shows a “bucket” of the water that is trapped between two successive blades of the screw. This bucket travels upward as the screw is rotated in the counterclockwise direction as viewed from the top. The volume of the bucket of water in makroid is always greater than the volume of water in the helicoid for screws of the same inner and outer diameters, same pitches, same number of blades, and same tilt angles.

Table I summarizes the percentage increase in the volume capacity of a 3-bladed makroid screw over a helicoid screw for screws with tilt angles from 15° to 45°. The “volume ratio” displayed for each type of screw is the ratio of the volume of water contained in the screw to the total volume of the screw between its blades. The geometric parameters of the screw were ones in general use today; namely, the ratio of the inner to outer radius of the screw is ½ and the pitch of the screw is equal to the screw's diameter. This table was computed by the inventor of the present invention using a MATLAB™ program, owned by MathWorks Inc.

As seem from Table 1, the steeper the tilt angle of the screw, the greater is the percentage increase of the makroid over the helicoid. Table 1 also shows that the actual quantity of fluid raised by a helicoid screw is roughly the same as the volume raised by a makroid screw with a tilt of about 5° steeper. For example, a makroid screw with a tilt of 30° raises about the same volume of water as a helicoid screw with a tilt of 25° (0.3547 and 0.3571, respectively). A steeper tilt of the screw is desired because it reduces the manufacturing and infrastructure costs of a screw installation

TABLE 1

| | Volume Ratio | | Percentage |
|---|---|---|---|
| Angle | Helicoid | Makroid | increase |
| 15° | 0.4314 | 0.4519 | 4.8% |
| 20° | 0.3954 | 0.4216 | 6.6% |
| 25° | 0.3571 | 0.3898 | 9.2% |
| 30° | 0.3154 | 0.3547 | 12.5% |
| 35° | 0.2659 | 0.3130 | 17.7% |
| 40° | 0.1997 | 0.2600 | 30.2% |
| 45° | 0.1287 | 0.1968 | 52.9% |

FIG. 9 expresses the data in Table 1 in graphical form for the percentage increase.

The first row of FIG. 10 shows one turn of single blade of a helicoid blade (Panel A) and a makroid blade (Panel B). Each of the two blades intersects the inner cylinder on a curve known as a helix. The straight white line segments along the blades are the so-called generators of the blade and are all horizontal when the screw is situated vertically as in FIG. 10. For the helicoid these generators are perpendicular to the inner cylinder and, if extended, pass through the center of the screw. For the makroid the generators are tangent to the inner cylinder along the helix.

The second row of FIG. 10 shows two flat annular blanks of metal from which a one turn of a blade can be formed. Each of the blanks is slit along a generator, although the slit is shown somewhat enlarged for visibility. FIG. 11 exhibits the machinery and manpower by which a flat blank is formed into a helicoid blade. As the blank is rotated by the two men the machinery successively bends and stretches the blank along a series of closely spaced generators until a single turn of a helicoid blade is formed. To form a makroid blade, the machinery can be reconfigured so that the bending and stretching is performed along the generators shown in Panel B of FIG. 10.

### Mathematical Derivation of a Makroid

In this section a mathematical derivation of the makroid surface is shown. A knowledge of analytic geometry as presented in a first course in Calculus is assumed on the part of the reader.

In a Cartesian xyz-coordinate system, the intrinsic equations of a makroid surface with inner radius a and outer radius b with intrinsic parameters s and r are:

x=a cos t+s sin t

y=a sin t−s cos t

z=ct

or

$$[ \begin{matrix}x \\ y \\ z\end{matrix} ] = [ \begin{matrix}a cos t \\ a sin t \\ ct\end{matrix} ] + s [ \begin{matrix}sin t \\ - cos t \\ 0\end{matrix} ] .$$

The spacing between turns of the makroid (the pitch of the screw) is 2πc. For one turn of the makroid the intrinsic parameters run through the following values:

0≤t≤2π and 0≤s≤\sqrt{b²−a²}.

A makroid with parameters a=1 and b=2 is shown in FIG. 12. The pitch of the blade is equal to 4 so that c=2/π. The stripes on the surface are along the generators of the blade as shown in FIG. 10.

The makroid blade intersects the inner cylinder of radius a at s=0 along the helical curve that has parametric equations

$$[ \begin{matrix}x \\ y \\ z\end{matrix} ] = [ \begin{matrix}a cos t \\ a sin t \\ ct\end{matrix} ]$$

The makroid blade intersects the outer cylinder of radius b at s=\sqrt{b²−a²}) along the helical curve that has parametric equations

$$[ \begin{matrix}x \\ y \\ z\end{matrix} ] = [ \begin{matrix}a cos t \\ a sin t \\ ct\end{matrix} ] + \sqrt{{b}^{2} - {a}^{2}} ) [ \begin{matrix}sin t \\ - cos t \\ 0\end{matrix} ] \\ or \\ [ \begin{matrix}x \\ y \\ z\end{matrix} ] = [ \begin{matrix}b cos ( t - δ ) \\ b sin ( t - δ ) \\ ct\end{matrix} ]$$

where

$$tan δ = \frac{\sqrt{{b}^{2} - {a}^{2}}}{a} .$$

The intersection of the makroid with the plane z=0 has the parametric equations in the xy-plane given by

x=a

y=−s

for

0≤s≤\sqrt{b²−a²}.

and is the straight-line segment shown in FIG. 13. (The two circles of radii a and b are not part of the makroid.)

The contents of the articles, patents, and patents applications and all other documents and electronically available information mentioned or cited herein, are hereby incorporated by reference in their entirety to the same extent as if each individual publication was specifically and individually indicated to be incorporated by reference. Applicant reserves the right to physically incorporate into this application any and all materials and information from any such articles, patents, patent applications, or other physical and electronic documents.

The terms and expressions used herein have been used as terms of description and not of limitation, and there is no intention in the use of such terms of excluding any equiva-lents of the features shown and described or portions thereof.

It is recognized that various modification are possible within the scope of the invention claimed. Thus, it should be understood that although the present invention has been specifically disclosed by preferred embodiments and other features, modification and variation of the invention embodied therein herein disclosed may be used by those skilled in the art, and that such modification and variations are con-sidered to be within the scope of this invention.

I claim:

1. An Archimedes screw comprising at least one makroid-shaped blade forming a bucket attached to an inner cylinder, the at least one makroid-shaped blade represented by parametric equations in an xyz-coordinate system in which an x-axis and a y-axis are in-plane axes crossing perpendicularly to each other in a cross-section of the at least one makroid-shaped blade with a z-axis crossing perpendicularly to the xy-axis plane along an axis of the inner cylinder, wherein: x=a*cos t−s*sin t; y=a*sin t+s*cos t; and z=c*t where a is a radius of the inner cylinder, c represents spacing between turns of the at least one makroid-shaped blade having a pitch of 2πc, and s and t are intrinsic parameters of the parametric equations.

2. The Archimedes screw of claim 1 having an outer cylinder partially or completely enclosing the at-least one makroid-shaped blade.

3. The Archimedes screw of claim 2 having one or more intertwined makroid-shaped blades.

4. The Archimedes screw of claim 1 wherein a volume of fluid in the bucket is about 10% more than a volume of fluid in a bucket formed by a helicoid shaped blade.

5. The Archimedes screw of claim 4 wherein the fluid is selected from a group consisting of water, Newtonian fluids, non-Newtonian fluids, organic solutions, inorganic solutions, and biological fluids.

6. A device for generating electrical energy from a moving body of water comprising:
a. an upper reservoir of moving water;
b. a lower reservoir; and
c. an Archimedes screw comprising at least one makroid-shaped blade forming a bucket attached to an inner cylinder, the at least one makroid-shaped blade represented by parametric equations in an xyz-coordinate system in which an x-axis and a y-axis are in-plane axes crossing perpendicularly to each other in a cross-section of the at least one makroid-shaped blade with a z-axis crossing perpendicularly to the xy-axis plane along an axis of the inner cylinder, wherein: x=a*cos t+s*sin t; y=a*sin t−s*cos t; and z=c*t where a is a radius of the inner cylinder, c represents spacing between turns of the at least one makroid-shaped blade having a pitch of 2πc, and s and t are intrinsic parameters of the parametric equations, wherein the Archimedes screw has an upper end in fluid communication with the moving water such that water movement to the lower reservoir rotates the Archimedes screw in such a manner whereby connection to a generator will generate electrical power.

7. The device of claim 6 having one or more intertwined makroid-shaped blades.

8. The device of claim 6 wherein a volume of water in a bucket formed by a single makroid-shaped blade is about 10% more than a volume of water in a bucket formed by a helicoid-shaped blade.

9. A method for moving a fluid comprising:
a. placing one end of a longitudinal axis of an Archimedes screw in fluid communication with a lower reservoir, the Archimedes screw having at least one makroid-shaped blade forming a bucket attached to an inner cylinder, the at least one makroid-shaped blade represented by parametric equations in an xyz-coordinate system in which an x-axis and a y-axis are in-plane axes crossing perpendicularly to each other in a cross-section of the at least one makroid-shaped blade with a z-axis crossing perpendicularly to the xy-axis plane along an axis of the inner cylinder, wherein: x=a*cos t+s*sin t; y=a*sin t−s*cos t; and z=c*t where a is a radius of the inner cylinder, c represents spacing between turns of the at least one makroid-shaped blade having a pitch of 2πc, and s and t are intrinsic parameters of the parametric equations;
b. locating an opposite end of the longitudinal axis of the Archimedes screw in contact with an upper reservoir to allow collection of the fluid; and
c. rotating the Archimedes screw such that the rotation moves the fluid from the lower reservoir to the upper reservoir.

10. The method of claim 9 wherein fluid is selected from a group consisting of water, Newtonian fluids, non-Newtonian fluids, organic solutions, inorganic solutions, and biological fluids.

11. The method of claim 9 wherein the fluid is water.

12. The method of claim 9 further for generating electricity comprising:
a. locating an Archimedes screw within a moving body of water having an upper reservoir and a lower reservoir, the Archimedes screw having at least one makroid-shaped blade forming a bucket attached to an inner cylinder, the at least one makroid-shaped blade represented by parametric equations in an xyz-coordinate system in which an x-axis and a y-axis are in-plane axes crossing perpendicularly to each other in a cross-section of the at least one makroid-shaped blade with a z-axis crossing perpendicularly to the xy-axis plane along an axis of the inner cylinder, wherein: x=a*cos t−s*sin t; y=a*sin t+s*cos t; and z−c*r where a is a radius of the inner cylinder, c represents spacing between turns of the at least one makroid-shaped blade having a pitch of 2πc, and s and t are intrinsic parameters of the parametric equations;
b. allowing the moving body of water to be in fluid communication with the upper reservoir such that movement of the moving body of water from the upper reservoir to the lower reservoir rotates the Archimedes screw; and
c. generating electricity from the rotating Archimedes screw.
